(19) United States
(12) Patent Application Publication
(10) Pub. No.: US 2019/0259980 A1
(43) Pub. Date: Aug. 22, 2019

(54) BATTERIES WITH SHORT CIRCUIT PREVENTION AND METHODS OF PREPARING THE SAME

(71) Applicant: Dagmy Motors Inc., Brooklyn, NY (US)

(72) Inventor: Jacob DAGMY, Brooklyn, NY (US)

(21) Appl. No.: 16/135,481

(22) Filed: Sep. 19, 2018

Related U.S. Application Data
(60) Provisional application No. 62/560,783, filed on Sep. 20, 2017.

(51) Int. Cl. H01M 2/02; H01M 2/30

(52) U.S. Cl. CPC H01M 2/0277; H01M 2/0285; H01M 2/30

(57) ABSTRACT

Embodiments described herein relate to safer electrochemical cells with reduced likelihood of short-circuiting and short circuit-related incidents. In some embodiments, the electrochemical cell includes a housing having a first end portion and a second end portion and defining an inner volume therebetween. An electrode assembly that includes an anode, a cathode, and a separator is disposed in the inner volume. A negative terminal is disposed at the first end portion of the housing and is electrically coupled to the anode of the electrode assembly. A positive terminal is disposed at the second end portion of the housing and is electrically coupled to the cathode of the electrode assembly. An insulating member is disposed between the negative terminal and the housing, and is configured to electrically insulate the housing from the negative terminal.

### CROSS-REFERENCE TO RELATED APPLICATIONS

This application claims the benefit of U.S. Provisional Application Ser. No. 62/560,783, entitled BATTERIES WITH SHORT CIRCUIT PREVENTION AND METHODS OF PREPARING THE SAME, filed on Sep. 20, 2017, the content of which is hereby incorporated by reference herein in its entirety for all purposes.

### BACKGROUND

Embodiments described herein relate to safer electrochemical cells with reduced likelihood of short-circuiting and short circuit-related incidents.

Batteries are often manufactured in a similar fashion regardless of their chemistry. The two prevailing types of battery architectures are cylindrical and prismatic cells. Cylindrical cells can be advantageous as they are often cheaper to produce and have the highest energy density available. They also have a very low manufacturing defect percentage. A typical design for cylindrical cells utilizes a housing that is a can-like structure. This allows for a cell to be manufactured on a current collector sheet, rolled into a “jellyroll”, and placed into the can. As a result of this design, one end of the can is the positive terminal, and the can's body and opposite end are collectively the negative terminal. Due to this design, short circuiting of cylindrical cells is relatively easy, which can be dangerous and can lead to battery failure, overheating, fire, thermal runaway, and/or an explosion.

### SUMMARY

Embodiments described herein relate to safer electrochemical cells with reduced likelihood of short-circuiting and short circuit-related incidents. In some embodiments, the electrochemical cell includes a housing having a first end portion and a second end portion and defining an inner volume therebetween. An electrode assembly that includes an anode, a cathode, and a separator is disposed in the inner volume. A negative terminal is disposed at the first end portion of the housing and is electrically coupled to the anode of the electrode assembly. A positive terminal is disposed at the second end portion of the housing and is electrically coupled to the cathode of the electrode assembly. An insulating member is disposed between the negative terminal and the housing, and is configured to electrically insulate the housing from the negative terminal.

### BRIEF DESCRIPTION OF THE DRAWINGS

FIG. 1 is a diagram of an electrochemical cell comprising a housing, a negative terminal, a positive terminal, a first insulating member, and an optional second insulating member, according to an embodiment.

FIG. 2A is a perspective view of an electrochemical cell comprising a cylindrical housing, according to an embodiment.

FIG. 2B is a schematic cross-section view of the electrochemical cell of FIG. 2A, according to an embodiment.

FIG. 3 is a schematic cross-section view of an electrochemical cell, according to an embodiment.

FIG. 4 is a schematic cross-section view of a portion of an electrochemical cell, according to an embodiment.

FIG. 5 is a schematic cross-section view of a portion of an electrochemical cell, according to an embodiment.

FIG. 6 is a schematic cross-section view of a portion of an electrochemical cell, according to an embodiment.

### DETAILED DESCRIPTION

Embodiments described herein relate to safer electrochemical cells with reduced likelihood of short-circuiting and short circuit-related incidents. In some embodiments, the electrochemical cell includes a housing having a first end portion and a second end portion and defining an inner volume therebetween. An electrode assembly that includes an anode, a cathode, and a separator is disposed in the inner volume. A negative terminal is disposed at the first end portion of the housing and is electrically coupled to the anode of the electrode assembly. A positive terminal is disposed at the second end portion of the housing and is electrically coupled to the cathode of the electrode assembly. An insulating member is disposed between the negative terminal and the housing, and is configured to electrically insulate the housing from the negative terminal.

As described herein, electrochemical cells can embody any suitable form factor and can be manufactured with a housing structure that results in one end of the housing including a positive terminal and the opposite end of the housing including a negative terminal. Battery housings are often formed from a single material such that the negative terminal is incidentally formed when the housing is formed and the negative terminal and battery housing are connected physically and electrically. In other words, the unitarily-formed housing structure has the same electrical potential as the negative terminal. Since the negative potential from the negative terminal extends throughout the housing structure, a portion of which is in close proximity to the positive terminal, it can be relatively easy to short circuit the cell. In other words, if a piece of conductive material (e.g., a piece of metal) comes into contact with both the housing and the positive terminal, a short circuit will immediately occur.

As a safety measure, electrochemical cells are often wrapped in a plastic film or “shrink-wrapped” with an insulating material (also referred to as a “coating”) to insulate the battery housing. The coating is often prone to damage and can be easily peeled or torn off, particularly in high volume pack usage. In particular, insulating coatings are often not included in automotive battery packaging. When the negatively charged housing underneath the coating is exposed (e.g., due to damage or removal of the insulating coating), any conductive material that incidentally contacts the housing and the positive terminal will result in a short circuit. In some instances, e.g., when the cells are sold in bulk, the electrochemical cells are not wrapped at all. Therefore, short circuits can occur in electrochemical cells, which can lead to an array of undesirable outcomes including but not limited to battery failure, overheating, fire, thermal runaway, and/or an explosion.

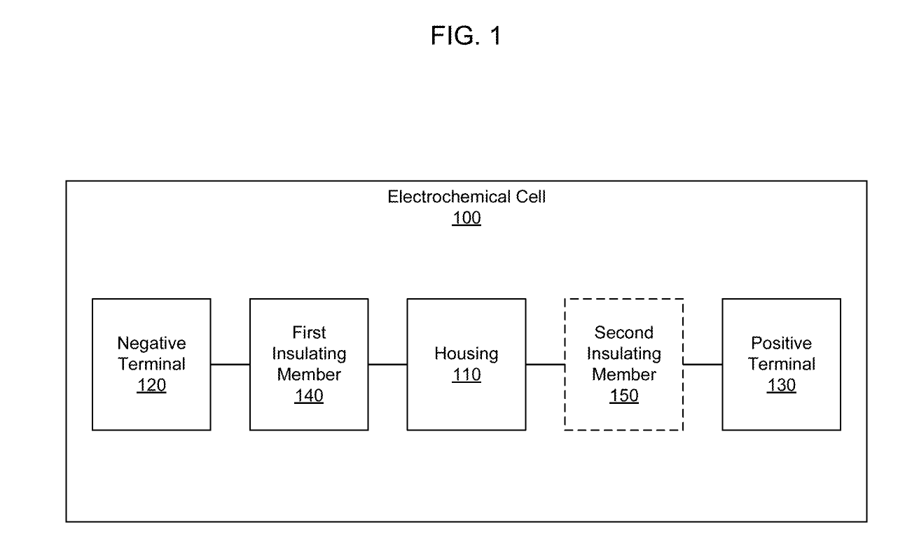

FIG. 1 shows a block diagram of an electrochemical cell 100 that includes a housing 110, a negative terminal 120, and a positive terminal 130, at least partially defining an inner volume (not shown). The inner volume is dimensioned and configured to contain an electrode assembly and/or a plurality of electrodes. The electrochemical cell 100 also includes a first insulating member 140 disposed between the housing 110 and the negative terminal 120, and optionally a second insulating member 150 disposed between the housing 110 and the positive terminal 130. The first insulating member 140 and/or the second insulating member 150 are individually or collectively configured to be connected to the housing 110 such that at least a portion of the housing 110 has a substantially neutral electrical potential relative to the negative terminal 120 and/or the positive terminal 130. In some embodiments, the first insulating member 140 can be fashioned to replace the housing 110 or a relatively large portion thereof. In other words, the housing 110 can be made from the same material as the first insulating member 140 such that the housing 110 has a substantially neutral charge due to the material from which it is made.

As described herein, the housing 110 at least partially defines an inner volume dimensioned and configured to receive an electrode assembly that includes an anode, a cathode, a separator, and an electrolyte. In other words, the housing 110 is the containment vessel within which the electrochemical process occurs to generate electrons at the anode during oxidation of the reducing species or reductant, generating an electrical current. In some embodiments, the housing 110 can be a single element. In some embodiments, the housing 110 can be a plurality of elements. In some embodiments, the plurality of elements of the housing 110 can be connected together directly. In some embodiments, the plurality of elements of the housing 110 can be connected to other elements of the electrochemical cell 100. In some embodiments, the plurality of elements of the housing 110 can be connected together indirectly with at least one other element of the electrochemical cell 100 interposed between the plurality of elements of the housing 110.

In some embodiments, the housing 110 can be any suitable shape or form-factor, including but not limited to, cylindrical, prismatic, rectangular, square, curved, flexible, any combination thereof, or any other shape or configuration suitable for an electrochemical cell. The housing 110 (also referred to herein as a “can”) includes a first end portion (not shown) and a second end portion (not shown) defining an inner volume therebetween. The housing 110 can be made from a wide variety of materials, including but not limited to, aluminum, zinc, steel, stainless steel, nickel, tin, copper, chromium, bronze, iron, lead, palladium, gold, cobalt, platinum, titanium, vanadium, molybdenum, rhodium, cadmium, tungsten, gallium, indium, iridium, bismuth, polonium, any alloy or admixture thereof, or any other suitable material. The housing 110 can be made from any other material, including plastics, glass, polymers, and/or composite materials. Furthermore, the housing 110 can be produced through any of a wide variety of processes or methods, including but not limited to extruding, smelting, pressing, punching, thermoforming, welding, cutting, or any other process or any combination thereof.

In some embodiments, the negative terminal 120 is disposed at the first end portion of the housing 110 and is electrically coupled to the anode of the electrode assembly. The negative terminal 120 is connected to the anode of the electrode assembly (e.g., via a negative terminal lead and an anode current collector) and also serves as an electrical contact for connecting the electrochemical cell 100 to an external load or charge. The positive terminal 130 is disposed at the second end portion of the housing 110 and is electrically coupled to the cathode of the electrode assembly. The positive terminal 130 is connected to the anode of the electrode assembly (e.g., via a positive terminal lead and a cathode current collector) and also serves as an electrical contact for connecting the electrochemical cell 100 to an external load or charge. In other words, the negative terminal 120 and the positive terminal 130 serve as the electrical conduit through which charge is transferred between the electrode assembly inside the housing 110 and the external (i.e., outside the housing 110) environment.

The negative terminal 120 and the positive terminal 130 are both electrically conductive and can be made from silver, copper, gold, aluminum, molybdenum, zinc, lithium, tungsten, brass, carbon-based materials, nickel, iron, palladium, platinum, tin, bronze, carbon steel, lead, titanium, graphene, stainless steel, any other suitable conductive material, and any alloy, admixture, or combination thereof.

In some embodiments, the negative terminal 120 and/or the positive terminal 130 can be a flat terminal, for example, a plate type terminal. In some embodiments, the housing 110 can be molded or otherwise formed in such a way that the negative terminal 120 or the positive terminal 130 is formed from the same material and at the same time as at least a portion of the housing 110. In some embodiments, the negative terminal 120 and/or the positive terminal 130 can be formed separately and fixedly coupled to one end of the housing 110 thereby at least partially sealing the inner volume. In such embodiments, the negative terminal 120 and/or the positive terminal 130 can be attached to the housing 110 via any suitable approach, including but not limited to gluing, welding, spot welding, ultrasonic welding, crimping, soldering, fusing, or any combination thereof.

As described herein, one of the key safety concerns with conventional electrochemical cells is that the housing 110 is often not insulated from the negative terminal 120, meaning that the housing 110 itself is negatively charged. Since the negatively charged housing 110 directly abuts the positive terminal 130 there is an increased likelihood of short-circuiting between the housing 110 and the positive terminal 130. Accordingly, in some embodiments described herein, the first insulating member 140 is disposed between the negative terminal 120 and the housing 110 and is configured to electrically insulate the housing 110 from the negative terminal 120. In other words, disposing the first insulating member 140 between the negative terminal 120 and the housing 110 ensures that the housing itself is not negatively charged thereby lowering the risk of accidental short circuit. In some embodiments, the housing 110 is separated from the positive terminal 130 by the first insulating member 140 in order to prevent the housing 110 from having a positive charge. In other words, preventing the housing 110 from having a positive charge means that there is a reduced risk of short-circuiting between the housing 110 and the negative terminal 120 when the housing 110 abuts the negative terminal 120.

In some embodiments, an electrochemical cell 100 includes a single insulating member. In some embodiments, the electrochemical cell 100 includes a plurality of insulating members. In some embodiments, the electrochemical cell 100 includes two insulating members. In some embodiments, the electrochemical cell 100 includes three insulating members. In some embodiments, the electrochemical cell 100 includes four insulating members. In some embodiments, the electrochemical cell 100 includes five insulating members. In some embodiments, the electrochemical cell 100 includes six insulating members. In some embodiments, the electrochemical cell 100 includes two to four insulating members. In some embodiments, the electrochemical cell 100 includes two to six insulating members. In some embodiments, the electrochemical cell 100 includes three or fewer insulating members.

In some embodiments, the first insulating member 140 can be dimensioned and configured to provide sufficient electrical insulation between the housing 110 of the electrochemical cell 100 and a terminal of the cell. In some embodiments, the first insulating member 140 can be considered an insulating band with a diameter or width substantially similar to the diameter or width of the housing 10. In some embodiments, the first insulating member 140 can have a height, where height relates to the dimension in the axial direction of the battery. In some embodiments, the first insulating member 140 can have a height that is less than about 2% of the overall axial direction height of the electrochemical cell 100. In some embodiments, the first insulating member 140 can have a height that is less than about 3%, less than about 4%, less than about 5% less than about 6%, less than about 7%, less than about 8%, less than about 9%, less than about 10%, less than about 11%, less than about 12%, less than about 13%, less than about 14%, less than about 15%, less than about 16%, less than about 17%, less than about 18%, less than about 19%, less than about 20%, less than about 21%, less than about 22%, less than about 23%, less than about 24%, less than about 25%, less than about 26%, less than about 27%, less than about 28%, less than about 29%, or less than 30% of the axial direction height of the overall electrochemical cell 100, inclusive of all values and ranges therebetween. In some embodiments, the first insulating member 140 can have a height that is between about 1% and about 30%, between about 2% and about 25%, between about 3% and about 20%, between about 4% and about 15%, between about 5% and about 10%, between about 6% and about 15%, between about 7% and about 20%, and between about 8% and about 30% of the overall axial direction height of the electrochemical cell 100, inclusive of all values and ranges therebetween. In some embodiments, the first insulating member 140 can have a height that is greater than about 1%, greater than about 5%, greater than about 10%, greater than about 15%, greater than about 20%, greater than about 25%, greater than about 30% of the overall axial direction height of the electrochemical cell 100, inclusive of all values and ranges therebetween.

In some embodiments, the first insulating member 140 can be interposed between the housing 110 and the negative terminal 120. In some embodiments, the first insulating member 140 can be interposed between the housing 110 and the positive terminal 130. In some embodiments, the second insulating member 150 can be interposed between the housing 110 and the negative terminal 120. In some embodiments, the second insulating member 150 can be interposed between the housing 110 and the positive terminal 130. In some embodiments, the first insulating member 140 can be interposed between the housing 110 and the negative terminal 120, and the second insulating member 150 can be interposed between the housing 110 and the positive terminal 130. In some embodiments, the first insulating member 140 can be interposed between the housing 110 and the positive terminal 130, and the second insulating member 150 can be interposed between the housing 110 and the negative terminal 120. In some embodiments, at least one of the first insulating member 140 and the second insulating member 150 can be interposed between separated pieces of the housing 110. In some embodiments, the first insulating member 140 and second insulating member 150 can be interchangeable and can provide a substantially similar insulating effect for the housing 110 in any position relative to the housing 110, the negative terminal 120, and the positive terminal 130.

In some embodiments, the first insulating member 140 is interposed between the housing 110 and the negative terminal 120 and the housing 110 has an electrical potential substantially different from the negative terminal 120 and/or the positive terminal 130. In some embodiments, the housing 110 can have a neutral electrical charge. In other words, the housing 110 can be completely insulated from the negative terminal 120. In some embodiments, the housing 110 may have a slightly negative charge where the slightly negative charge is less negative than the negative charge of the negative terminal 120. In some embodiments, the housing 110 may have a slightly positive charge where the slightly positive charge is less positive than the positive charge of the positive terminal 130. In some embodiments, at least a portion of the housing 110 may have a slightly positive or slightly negative charge and may still be considered neutral or grounded. In some embodiments, a conductive material can have a relatively high electrical impedance, allowing a slight charge to the housing 110.

In some embodiments, the first insulating member 140 can be dimensioned and configured such that sufficient physical separation is provided between the negative terminal 120 and/or the positive terminal 130 and the housing 110. In other words, in some embodiments, the first insulating member 140 can have a “height” that predetermines the physical separation between the housing and the negative terminal 120. In some embodiments, the height of the first insulating member 140 can be greater than about 20 mm, greater than about 10 mm, greater than about 5 mm, greater than about 1 mm, greater than about 500 μm, greater than about 100 μm, and all ranges and values therebetween. In some embodiments, the height of the first insulating member 140 can be between about 100 μm and about 20 mm, between about 500 μm and about 20 mm, between about 1 mm and about 20 mm, between about 1 mm and about 15 mm, between about 1 mm and about 12 mm, between about 1 mm and about 10 mm, between about 1 mm and about 8 mm, between about 1 mm and about 6 mm, between about 1 mm and about 4 mm, between about 1 mm and about 2 mm, and all ranges and values therebetween. In some embodiments, the height of the first insulating member 140 can be less than about 20 mm, less than about 15 mm, less than about 10 mm, less than about 8 mm, less than about 6 mm, less than about 4 mm, less than about 2 mm, less than about 1 mm, less than about 500 μm, less than about 250 μm, less than about 100 μm, and all ranges and values therebetween.

In some embodiments, the first insulating member 140 can be dimensioned and configured such that the sufficient physical separation between the negative terminal 120 and/or the positive terminal 130 and the housing 110 is determined by the “thickness” of the first insulating member 140, where thickness is the radial direction dimensional measurement. In some embodiments, the first insulating member 140 can have a thickness of greater than about 10 mm, greater than about 9 mm, greater than about 8 mm, greater than about 7 mm, greater than about 6 mm, greater than about 5 mm, greater than about 4 mm, greater than about 3 mm, greater than about 2 mm, greater than about 1 mm, greater than about 500 μm, greater than about 250 μm, greater than about 100 μm, greater than about 50 μm, greater than about 10 μm, and all ranges and values therebetween. In some embodiments, the first insulating member 140 can have a thickness of between about 10 μm and 10 mm, between about 100 μm and about 9 mm, between about 250 μm and 8 mm, between about 500 μm and about 7 mm, between about 1 mm and about 6 mm, between about 2 mm and about 5 mm, between about 3 mm and about 4 mm, and all ranges and values therebetween. In some embodiments, the first insulating member 140 can have a thickness of less than about 10 mm, less than about 9 mm, less than about 8 mm, less than about 7 mm, less than about 6 mm, less than about 5 mm, less than about 4 mm, less than about 3 mm, less than about 2 mm, less than about 1 mm, less than about 500 μm, less than about 250 μm, less than about 100 μm, and all ranges and values therebetween.

In some embodiments, the first insulating member 140 can be made of any sufficiently electrically insulating material. In some embodiments, first insulating member 140 can be made from any of a polymer, a plastic, ceramic, glass, fiberglass, acrylonitrile-butadiene-styrene, acetate, acrylic, polymerized formaldehyde, epoxy-fiberglass laminate, polystyrene, high impact polystyrene, polyimide, fluoropolymer, polyvinylidene fluoride, melamine laminated with woven glass, unfilled polyimide, mica, rubber, neoprene, aromatic polyamides, nylon, polyetheretherketone, polyethylene terephthalate, glycol-modified polyethylene terephthalate, phenolics, perfluoroalkoxy, polycarbonates, polyesters, polyolefins, polysulfones, polyurethanes, polytetrafluoroethylene, crosslinked polystyrene, polyphenylene sulfide, silicone-fiberglass resin, unfilled polyetherimide, vulcanized rubber, vulcanized fiber, dacron, mylar, polyvinylfluoride, polychlorinated biphenyls, and combinations thereof.

In some embodiments, the first insulating member 140 can be coupled with the housing 110. For example, the first insulating member 140 can be fixedly coupled (i.e., permanently connected or attached) to the housing 110. In some embodiments, the first insulating member 140 can be coupled with the housing 110 and the negative terminal 120. In some embodiments, the first insulating member 140 can be coupled with the housing 110 and the positive terminal 130. In some embodiments, the first insulating member 140 can be formed as a single component that is then interposed between the housing 110 and the negative terminal 120. In some embodiments, the first insulating member 140 can be formed as a single component that is then interposed between the housing 110 and the positive terminal 130. In some embodiments, the first insulating member 140 can be formed as a plurality of discrete parts that are then combined to form the first insulating member 140.

In some embodiments, the first insulating member 140 can be glued to one or both of the housing 110 and a terminal. In some embodiments, the first insulating member 140 can be thermochemically fused to at least one of the housing 110, the negative terminal 120, and the positive terminal 130. In some embodiments, at least one of the housing 110, the negative terminal 120, or the positive terminal 130 can be dimensioned and configured to have a perpendicularly aligned lip and the first insulating member 140 can be dimensioned and configured to have a groove into which the lip of the housing 110 can be securely fitted. In some embodiments, at least one of the housing 110, the negative terminal 120, or the positive terminal 130, as well as the first insulating member 140, can have perpendicularly aligned lips, the lips abutted and calendared or crimped in order to make abutment permanent. In some embodiments, the first insulating member 140 can be fused to one or both of the housing 110 and a terminal. In some embodiments, the first insulating member 140 can be thermally bonded to one or both of the housing 110 and a terminal. In some embodiments, the abutting surface of the housing 110 and/or a terminal can be roughened and the first insulating member 140 can be at least partially melted to join or affix one to the other. In some embodiments, the abutting surface of the first insulating member 140 can be joined or affixed to the abutting surface of the housing 110 and/or the abutting surface of a terminal can be brazed to make abutment permanent. In some embodiments, the abutting surface of the first insulating member 140 can be joined or affixed to the abutting surface of the housing 110 and/or the abutting surface of a terminal can be welded to make abutment permanent. In some embodiments, the abutting surface of the first insulating member 140 can be joined or affixed to the abutting surface of the housing 110 and/or the abutting surface of a terminal can be soldered to make abutment permanent. In some embodiments, a cylindrical fastening mechanism such as a screw thread or a spiral ridge, can be formed in the housing 110, the negative terminal 120, the positive terminal 130, and/or the first insulating member 140. In some embodiments, the first insulating member 140 can be screw fitted together with the housing 110 and/or a terminal such that the frictional engagement of threaded elements is sufficient to prevent linear motion being converted to rotary motion. In other words, the threaded elements do not become unthreaded due to motion, stress, temperature changes, and/or pressure changes within the electrochemical cell 100 or without.

In some embodiments, the electrochemical cell 100 can further comprise a second insulating member 150. In some embodiments, the second insulating member 150 can be dimensioned and configured similarly to the first insulating member 140. In some embodiments, the second insulating member 150 can be made from any of the materials disclosed herein and/or from which the first insulating member 140 can be made. In some embodiments, the second insulating member 150 can be dimensioned and configured such that the second insulating member 150 is substantially different from the first insulating member 140. In some embodiments, wherein the first insulating member 140 is interposed between the housing 110 and the negative terminal 120, the second insulating member 150 can be interposed between the housing 110 and the positive terminal 130. In some embodiments, wherein the first insulating member 140 is interposed between the housing 110 and the positive terminal 130, the second insulating member 150 can be interposed between the housing 110 and the negative terminal 120. In some embodiments, the first insulating member 140 and second insulating member 150 can be interposed anywhere within the electrochemical cell 100.

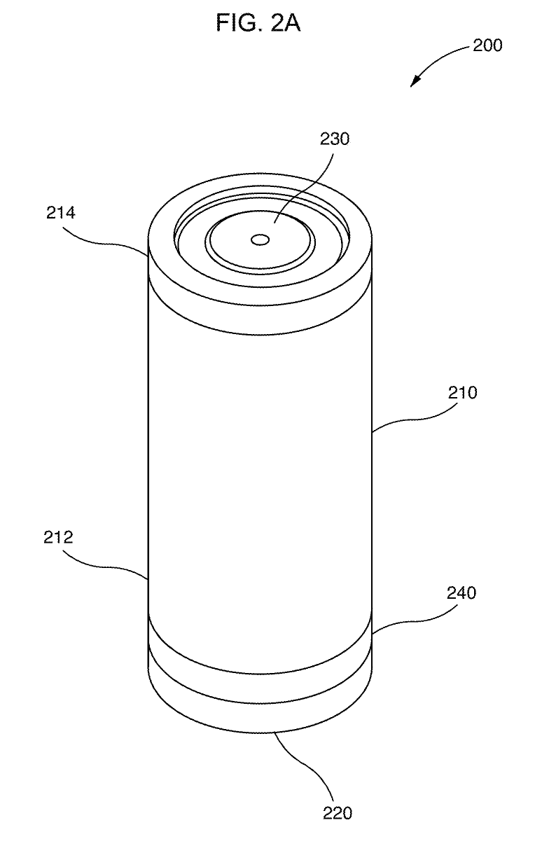

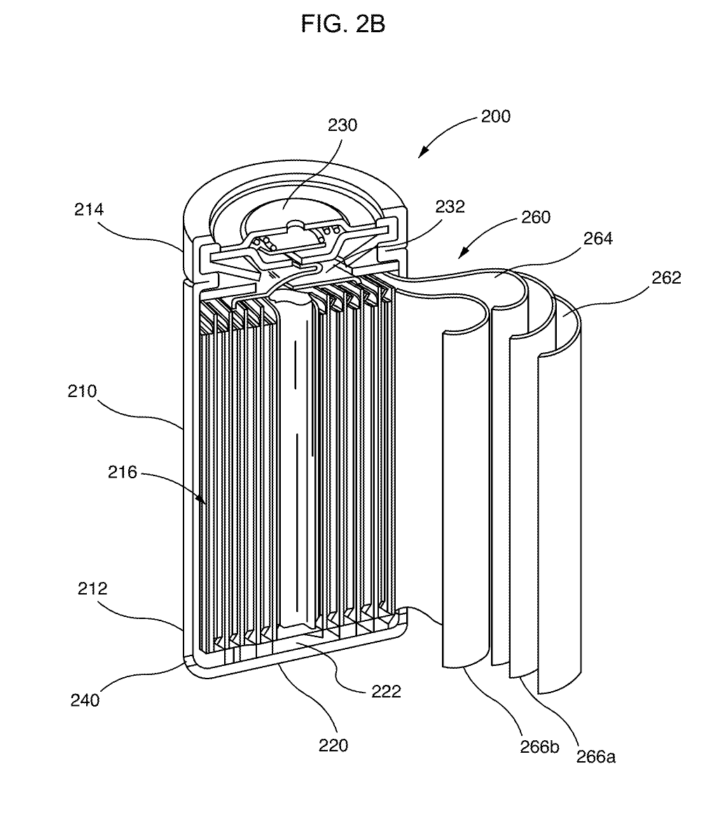

FIGS. 2A and 2B illustrates an electrochemical cell 200 according to an embodiment. As described above with reference to the electrochemical cell 100, the electrochemical cell 200 (also referred to herein as “battery” or “cell”) is configured to improve safety and have a reduced likelihood of short-circuiting and/or other short circuit-related events. In some embodiments, portions and/or aspects of the electrochemical cell 200 are substantially similar in form and/or function to the corresponding portions and/or aspects of the electrochemical cell 100 described above with reference to FIG. 1. Accordingly, such similar portions and/or aspects are not described in further detail herein.

As shown in FIGS. 2A and 2B, the electrochemical cell 200 that includes a housing 210 having a first end portion 212 and a second end portion 214 and defines an inner volume 216 therebetween. An electrode assembly 260 that includes an anode 262, a cathode 264, a first separator 266a, and a second separator 266b (collectively referred to herein as “separator 266”) are disposed in the inner volume 216. A negative terminal 220 is disposed at the first end portion 212 of the housing 210 and is electrically coupled to the anode 262 of the electrode assembly 260. A positive terminal 230 is disposed at the second end portion 214 of the housing 210 and is electrically coupled to the cathode 264 of the electrode assembly 260. An insulating member 240 is disposed between the negative terminal 220 and the housing 210, and is configured to electrically insulate the housing 210 from the negative terminal 220. Although the first insulating member 240 is shown proximate to the negative terminal 220 in FIGS. 2A and 2B, the first insulating member 240 can be in any location provided the second end portion 214 has a substantially neutral electrical potential relative to the positive terminal 230. In other words, as long as the second end portion 214 is substantially neutral so that accidental short-circuits cannot occur between the positive terminal 230 and the housing 210, the first insulating member 240 can be disposed in any location and/or position in the housing 210. In some embodiments, the electrochemical cell 200 can include two or more insulating members. For example, the first insulating member 240 can be a first insulating member and a second insulating member (not shown) can be disposed between the housing 210 and the positive terminal 230. In some embodiments, the first insulating member 240 and/or any additional insulating members are individually and/or collectively configured to be connected to the housing 210 such that at least a portion of the housing 210 has a substantially neutral electrical potential relative to the positive terminal 230 and/or the negative terminal 220.

As described herein, the housing 210 (also referred to herein as a “can”) at least partially defines an inner volume 216 dimensioned and configured to receive the electrode assembly 260 that includes the anode 262 (also referred to as “negative electrode”), the cathode 264 (also referred to as “positive electrode”), the separators 266, and electrolyte (not shown). In other words, the housing 210 is the containment vessel within which the electrochemical process occurs to generate electrons at the anode 262 during oxidation of the reducing species or reductant, generating an electrical current. In some embodiments, the housing 210 can be a single element. In some embodiments, the housing 210 can be a plurality of elements. In some embodiments, the plurality of elements of the housing 210 can be connected together directly. In some embodiments, the plurality of elements of the housing 210 can be connected to other elements of the electrochemical cell 200. In some embodiments, the plurality of elements of the housing 210 can be connected together indirectly with at least one other element of the electrochemical cell 200 interposed between the plurality of elements of the housing 210.

In some embodiments, the housing 210 can be any suitable shape or form-factor, including but not limited to, cylindrical, prismatic, rectangular, square, curved, flexible, any combination thereof, or any other shape or configuration suitable for an electrochemical cell. The housing 210 can be made from a wide variety of materials, including but not limited to, aluminum, zinc, steel, stainless steel, nickel, tin, copper, chromium, bronze, iron, lead, palladium, gold, cobalt, platinum, titanium, vanadium, molybdenum, rhodium, cadmium, tungsten, gallium, indium, iridium, bismuth, polonium, any alloy or admixture thereof, or any other suitable material. Furthermore, the housing 210 can be produced through any of a wide variety of processes or methods, including but not limited to extruding, smelting, pressing, punching, thermoforming, welding, cutting, or any other process or any combination thereof.

In some embodiments, the negative terminal 220 is disposed at the first end portion 212 of the housing 210 and is in electrical communication with the anode 262. The negative terminal 220 is connected to the anode 262 via a negative terminal lead 222, thereby providing an electrical pathway for the anode 262 to be connected to an external load or charge. In some embodiments, the positive terminal 230 is disposed at the second end portion 214 of the housing 210 and is in electrical communication with the cathode 264. The positive terminal 230 is connected to the cathode 264 via a positive terminal lead 232, thereby providing an electrical pathway for the cathode 264 to be connected to an external load or charge. In other words, the negative terminal 220 and the positive terminal 230 serve as the electrical conduit through which charge is transferred between the electrode assembly 260 inside the housing 210 and the external (i.e., outside the housing 210) environment.

The negative terminal 220 and the positive terminal 230 are both electrically conductive and can be made from silver, copper, gold, aluminum, molybdenum, zinc, lithium, tungsten, brass, carbon-based materials, nickel, iron, palladium, platinum, tin, bronze, carbon steel, lead, titanium, stainless steel, any other suitable conductive material, and any alloy, admixture, or combination thereof.

In some embodiments, the negative terminal 220 and/or the positive terminal 230 can be a flat terminal, for example, a plate type terminal. In some embodiments, the housing 210 can be molded or otherwise formed in such a way that the negative terminal 220 or the positive terminal 230 is formed from the same material and at the same time as at least a portion of the housing 210. In some embodiments, the negative terminal 220 and/or the positive terminal 230 can be formed separately and fixedly coupled to one end of the housing 210 thereby at least partially sealing the inner volume. In such embodiments, the negative terminal 220 and/or the positive terminal 230 can be attached to the housing 210 via any suitable approach, including but not limited to gluing, welding, spot welding, ultrasonic welding, crimping, soldering, fusing, or any combination thereof.

In some embodiments, the anode 262 and/or cathode 264 and/or separator 266 can be formed as thin sheets and are assembled in a laminate structure with the separators 266 interposed between the anode 262 and cathode 264. In some embodiments, the laminate sheet of anode 262, cathode 264, and interposed separators 266 can be wound tightly around a point, forming the electrode assembly 260. In some embodiments, the wound electrode assembly 260 can be formed from winding the laminate sheet around one end of the laminate sheet. In some embodiments, the wound electrode assembly 260 can be formed from folding the laminate sheet over a fold point and then winding the folded laminate sheet around one end of the folded laminate sheet. In some embodiments, the electrode assembly 260 can be formed by connecting the laminate sheet to a pin, rod, or other columnar structure (not shown) and then winding the laminate sheet around the pin, rod, or other columnar structure.

In some embodiments, the anode 262 can be made of lithium, magnesium, aluminum, zinc, chromium, iron, nickel, tin, lead, hydrogen, copper, silver, palladium, mercury, gold, other suitable materials, or any alloy, admixture, or combination thereof.

The cathode 264 can be made of ferrate, iron oxide, cuprous oxide, iodate, cupric oxide, mercuric oxide, cobaltic oxide, manganese dioxide, lead dioxide, silver oxide, oxygen, nickel oxyhydroxide, nickel dioxide, silver peroxide, permanganate, bromate, other suitable materials, and any alloy, admixture, or combination thereof.

The separator 266 disposed between the negative electrode 262 and positive electrode 264 in the electrode assembly 260 can be a very thin and/or porous film or sheet formed from any appropriate polymer material, according to an embodiment. The separator or plurality of separators 266 can be made from polyethylene, polypropylene, paper, polyester, polylactic acid, polyphenylene sulfide, para-aramide, fluorines, SETELA™, cotton, nylon, polyesters, glass, polyethylene, polytetrafluoroethylene, polyvinyl chloride, ceramic, rubber, asbestos, wood, polyolefins, polyoxymethylene, isotactic poly (4-methyl-1-pentene), polyethylene-polypropylene, polystyrene-polypropylene, poly(ethylene terephthalate), polyvinylidene fluoride, siloxane grafted polyethylene, micro-porous poly(methyl methacrylate)-grafted polyethylene, polytriphenylamine, any other material suitably configured and dimensioned to allow for ion communication between the cathode and the anode, and any admixture or combination thereof.

As described herein, one safety concern with conventional electrochemical cells is that the housing 210 is often not insulated from the negative terminal 220, meaning that the housing 210 itself is negatively charged. Since the negatively charged housing 210 directly abuts the positive terminal 230 there is an increased likelihood of short-circuiting between the housing 210 and the positive terminal 230. Accordingly, in some embodiments described herein, such as in FIGS. 2A and 2B, the insulating member 240 is disposed between the negative terminal 220 and the housing 210 and is configured to electrically insulate at least a majority of the housing 210 from the negative terminal 220. In other words, disposing the insulating member 240 between the negative terminal 220 and the housing 210 ensures that the housing itself is not negatively charged thereby lowering the risk of accidental short circuit.

In some embodiments, the insulating member 240 can be dimensioned and configured to provide sufficient electrical insulation between the housing 210 of the electrochemical cell 200 and a terminal of the cell. In some embodiments, the insulating member 240 can be considered an insulating band with a diameter or width substantially similar to the diameter or width of the housing 210. In some embodiments, the insulating member 240 can have a height, where height relates to the dimension in the axial direction of the battery. In some embodiments, the insulating member 240 can have a height that is less than about 2% of the overall axial direction height of the electrochemical cell 200. In some embodiments, the insulating member 240 can have a height that is less than about 3%, less than about 4%, less than about 5% less than about 6%, less than about 7%, less than about 8%, less than about 9%, less than about 10%, less than about 11%, less than about 12%, less than about 13%, less than about 14%, less than about 15%, less than about 16%, less than about 17%, less than about 18%, less than about 19%, less than about 20%, less than about 21%, less than about 22%, less than about 23%, less than about 24%, less than about 25%, less than about 26%, less than about 27%, less than about 28%, less than about 29%, or less than 30% of the axial direction height of the overall electrochemical cell 200, inclusive of all values and ranges therebetween. In some embodiments, the insulating member 240 can have a height that is between about 1% and about 30%, between about 2% and about 25%, between about 3% and about 20%, between about 4% and about 15%, between about 5% and about 10%, between about 6% and about 15%, between about 7% and about 20%, and between about 8% and about 30% of the overall axial direction height of the electrochemical cell 200, inclusive of all values and ranges therebetween. In some embodiments, the insulating member 240 can have a height that is greater than about 1%, greater than about 5%, greater than about 10%, greater than about 15%, greater than about 20%, greater than about 25%, greater than about 30% of the overall axial direction height of the electrochemical cell 200, inclusive of all values and ranges therebetween.

In some embodiments, the insulating member 240 can be interposed between the housing 210 and the negative terminal 220. In some embodiments, the insulating member 240 can be interposed between the housing 210 and the positive terminal 230. In some embodiments, the insulating member 240 can be a “first” insulating member 240 and a second insulating member (not shown) can be interposed between the housing 210 and the negative terminal 220. In some embodiments, the second insulating member can be interposed between the housing 210 and the positive terminal 230. In some embodiments, the first insulating member 240 can be interposed between the housing 210 and the negative terminal 220, and the second insulating member can be interposed between the housing 210 and the positive terminal 230. In some embodiments, the insulating member 240 can be interposed between the housing 210 and the positive terminal 230, and the second insulating member can be interposed between the housing 210 and the negative terminal 220. In some embodiments, at least one of the first insulating member 240 and the second insulating member can be interposed between separated pieces of the housing 210. In some embodiments, the first insulating member 240 and second insulating member can be interchangeable and can provide a substantially similar insulating effect for the housing 210 in any position relative to the housing 210, the negative terminal 220, and the positive terminal 230.

In some embodiments, the insulating member 240 is interposed between the housing 210 and the negative terminal 220 and the housing 210 has an electrical potential substantially different from the negative terminal 220 and/or the positive terminal 230. In some embodiments, the housing 210 can have a neutral electrical charge. In other words, the housing 210 can be completely insulated from the negative terminal 220. In some embodiments, the housing 210 may have a slightly negative charge where the slightly negative charge is less negative than the negative charge of the negative terminal 220. In some embodiments, the housing 210 may have a slightly positive charge where the slightly positive charge is less positive than the positive charge of the positive terminal 230. In some embodiments, at least a portion of the housing 210 may have a slightly positive or slightly negative charge and may still be considered neutral or grounded. In some embodiments, a conductive material can have a relatively high electrical impedance, allowing a slight charge to the housing 110.

In some embodiments, the insulating member 240 can be dimensioned and configured such that sufficient physical separation is provided between the negative terminal 220 and/or the positive terminal 230 and the housing 210. In other words, in some embodiments, the insulating member 240 can have a “height” that predetermines the physical separation between the housing and the negative terminal 220. In some embodiments, the height of the insulating member 240 can be greater than about 20 mm, greater than about 10 mm, greater than about 5 mm, greater than about 1 mm, greater than about 500 μm, or greater than about 100 μm, inclusive of all ranges and values therebetween. In some embodiments, the height of the insulating member 240 can be between about 100 μm and about 20 mm, between about 500 μm and about 20 mm, between about 1 mm and about 20 mm, between about 1 mm and about 15 mm, between about 1 mm and about 12 mm, between about 1 mm and about 10 mm, between about 1 mm and about 8 mm, between about 1 mm and about 6 mm, between about 1 mm and about 4 mm, or between about 1 mm and about 2 mm, inclusive of all ranges and values therebetween. In some embodiments, the height of the insulating member 240 can be less than about 20 mm, less than about 15 mm, less than about 10 mm, less than about 8 mm, less than about 6 mm, less than about 4 mm, less than about 2 mm, less than about 1 mm, less than about 500 μm, less than about 250 μm, or less than about 100 μm, inclusive of all ranges and values therebetween.

In some embodiments, the insulating member 240 can be dimensioned and configured such that the sufficient physical separation between the negative terminal 220 and/or the positive terminal 230 and the housing 210 is determined by the “thickness” of the first insulating member 240, where thickness is the radial direction dimensional measurement. In some embodiments, the insulating member 240 can have a thickness of greater than about 10 mm, greater than about 9 mm, greater than about 8 mm, greater than about 7 mm, greater than about 6 mm, greater than about 5 mm, greater than about 4 mm, greater than about 3 mm, greater than about 2 mm, greater than about 1 mm, greater than about 500 μm, greater than about 250 μm, greater than about 100 μm, greater than about 50 μm, greater than about 10 μm, and all ranges and values therebetween. In some embodiments, the insulating member 240 can have a thickness of between about 10 μm and 10 mm, between about 100 μm and about 9 mm, between about 250 μm and 8 mm, between about 500 μm and about 7 mm, between about 1 mm and about 6 mm, between about 2 mm and about 5 mm, between about 3 mm and about 4 mm, and all ranges and values therebetween. In some embodiments, the insulating member 240 can have a thickness of less than about 10 mm, less than about 9 mm, less than about 8 mm, less than about 7 mm, less than about 6 mm, less than about 5 mm, less than about 4 mm, less than about 3 mm, less than about 2 mm, less than about 1 mm, less than about 500 μm, less than about 250 μm, less than about 100 μm, and all ranges and values therebetween.

In some embodiments, the insulating member 240 can be made of any sufficiently electrically insulating material. In some embodiments, insulating member 240 can be made from any of a polymer, a plastic, ceramic, glass, fiberglass, acrylonitrile-butadiene-styrene, acetate, acrylic, polymerized formaldehyde, epoxy-fiberglass laminate, polystyrene, high impact polystyrene, polyimide, fluoropolymer, polyvinylidene fluoride, melamine laminated with woven glass, unfilled polyimide, mica, rubber, neoprene, aromatic polyamides, nylon, polyetheretherketone, polyethylene terephthalate, glycol-modified polyethylene terephthalate, phenolics, perfluoroalkoxy, polycarbonates, polyesters, polyolefins, polysulfones, polyurethanes, polytetrafluoroethylene, crosslinked polystyrene, polyphenylene sulfide, silicone-fiberglass resin, unfilled polyetherimide, vulcanized rubber, vulcanized fiber, dacron, mylar, polyvinylfluoride, polychlorinated biphenyls, and combinations thereof.

In some embodiments, the insulating member 240 can be coupled with the housing 210. For example, the insulating member 240 can be fixedly coupled (i.e., permanently connected or attached) to the housing 210. In some embodiments, the insulating member 240 can be coupled with the housing 210 and the negative terminal 220. In some embodiments, the insulating member 240 can be coupled with the housing 210 and the positive terminal 230. In some embodiments, the insulating member 240 can be formed as a single component that is then interposed between the housing 210 and the negative terminal 220. In some embodiments, the insulating member 240 can be formed as a single component that is then interposed between the housing 210 and the positive terminal 230. In some embodiments, the insulating member 240 can be formed as a plurality of discrete parts that are then combined to form the insulating member 240.

In some embodiments, the insulating member 240 can be glued to one or both of the housing 210 and a terminal. In some embodiments, the insulating member 240 can be thermochemically fused to at least one of the housing 210, the negative terminal 220, and the positive terminal 230. In some embodiments, at least one of the housing 110, the negative terminal 220, or the positive terminal 230 can be dimensioned and configured to have a perpendicularly aligned lip and the insulating member 240 can be dimensioned and configured to have a groove into which the lip of the housing 210 can be securely fitted. In some embodiments, at least one of the housing 210, the negative terminal 220, or the positive terminal 230, as well as the insulating member 240, can have perpendicularly aligned lips, the lips abutted and calendared or crimped in order to make abutment permanent. In some embodiments, the insulating member 240 can be fused to one or both of the housing 210 and a terminal. In some embodiments, the insulating member 240 can be thermally bonded to one or both of the housing 210 and a terminal. In some embodiments, the abutting surface of the housing 210 and/or a terminal can be roughened and the insulating member 240 can be at least partially melted to join or affix one to the other. In some embodiments, the abutting surface of the insulating member 240 can be joined or affixed to the abutting surface of the housing 210 and/or the abutting surface of a terminal can be brazed to make abutment permanent. In some embodiments, the abutting surface of the insulating member 240 can be joined or affixed to the abutting surface of the housing 210 and/or the abutting surface of a terminal can be welded to make abutment permanent. In some embodiments, the abutting surface of the insulating member 240 can be joined or affixed to the abutting surface of the housing 210 and/or the abutting surface of a terminal can be soldered to make abutment permanent. In some embodiments, a cylindrical fastening mechanism such as a screw thread or a spiral ridge, can be formed in the housing 210, the negative terminal 220, the positive terminal 230, and/or the insulating member 240. In some embodiments, the insulating member 240 can be screw fitted together with the housing 210 and/or a terminal such that the frictional engagement of threaded elements is sufficient to prevent linear motion being converted to rotary motion. In other words, the threaded elements do not become unthreaded due to motion, stress, temperature changes, and/or pressure changes within the electrochemical cell 200 or without.

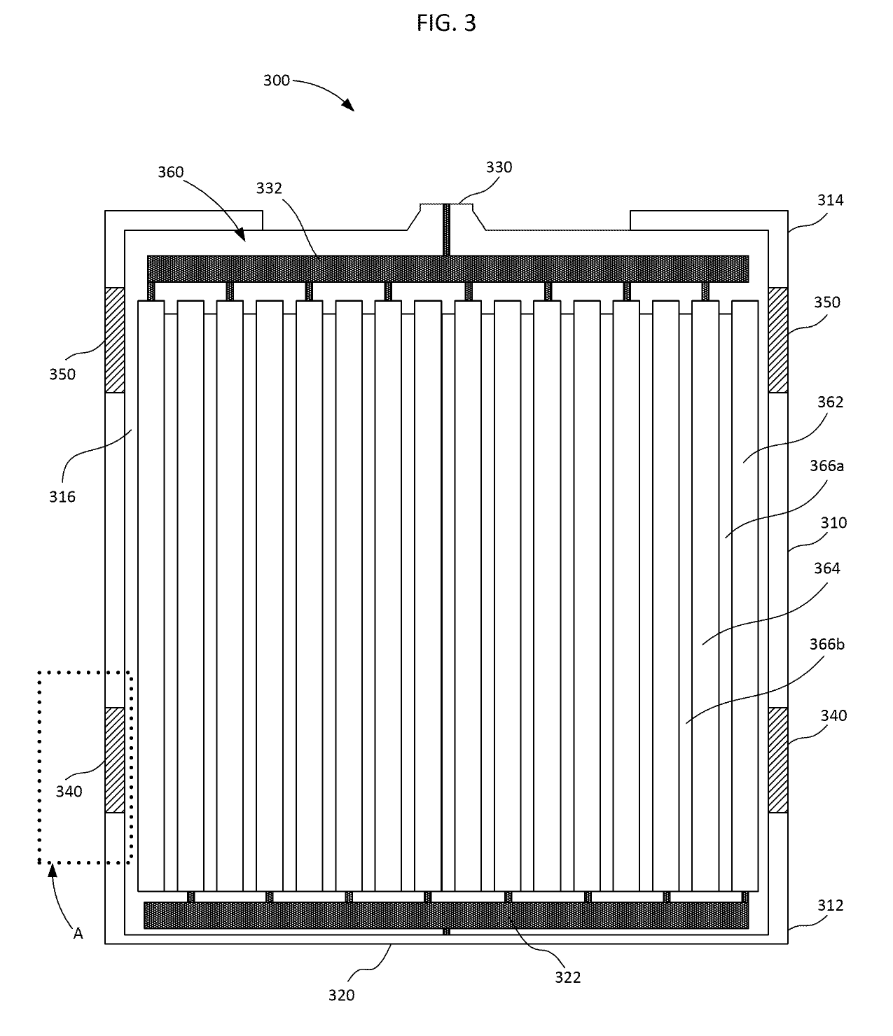

FIG. 3 illustrates an electrochemical cell 300 according to an embodiment. As described above with reference to the electrochemical cells 100 and 200, the electrochemical cell 300 (also referred to herein as “battery” or “cell”) is configured to improve safety and have a reduced likelihood of short-circuiting and/or other short circuit-related events. In some embodiments, portions and/or aspects of the electrochemical cell 300 are substantially similar in form and/or function to the corresponding portions and/or aspects of the electrochemical cell 100 described above with reference to FIG. 1 and/or the electrochemical cell 200 described above with reference to FIGS. 2A and 2B. Accordingly, such similar portions and/or aspects are not described in further detail herein.

As shown in FIG. 3, the electrochemical cell 300 includes the housing 310 including a first end portion 312 and a second end portion 314, defining an inner volume 316 therebetween. An electrode assembly 360 that includes an anode 362, a cathode 364, a first separator 366a, and a second separator 366b (collectively referred to herein as “separator 366”) are disposed in the inner volume 316. A negative terminal 320 is disposed at the first end portion 312 of the housing 310 and is electrically coupled to the anode 362 of the electrode assembly 360. A positive terminal 330 is disposed at the second end portion 314 of the housing 310 and is electrically coupled to the cathode 364 of the electrode assembly 360. A first insulating member 340 is disposed between the negative terminal 320 and the housing 310, and is configured to electrically insulate the housing 310 from the negative terminal 320. Although the first insulating member 340 is shown proximate the negative terminal 320 in FIG. 3, the first insulating member 340 can be in any location provided the second end portion 314 has a substantially neutral electrical potential relative to the positive terminal 330. In other words, as long as the second end portion 314 is substantially neutral so that accidental short-circuits cannot occur between the positive terminal 330 and the housing 310, the first insulating member 340 can be disposed in any location and/or position in the housing 310. In some embodiments, the electrochemical cell 300 can include two or more insulating members. For example, the electrochemical cell 300 can include a second insulating member 350 disposed between the housing 310 and the positive terminal 330. In some embodiments, the first insulating member 340 and/or second insulating member 350 individually and/or collectively configured to be connected to the housing 310 such that at least a portion of the housing 310 has a substantially neutral electrical potential relative to the positive terminal 330 and/or the negative terminal 320.

In some embodiments, the negative terminal 320 is disposed at the first end portion 312 of the housing 310 and is in electrical communication with the anode 362. The negative terminal 320 is connected to the anode 362 via a negative terminal lead 322, thereby providing an electrical pathway for the anode 362 to be connected to an external load or charge. In some embodiments, the positive terminal 330 is disposed at the second end portion 314 of the housing 310 and is in electrical communication with the cathode 364. The positive terminal 330 is connected to the cathode 364 via a positive terminal lead 332, thereby providing an electrical pathway for the cathode 364 to be connected to an external load or charge. In other words, the negative terminal 320 and the positive terminal 330 serve as the electrical conduit through which charge is transferred between the electrode assembly 360 inside the housing 310 and the external (i.e., outside the housing 310) environment.

In some embodiments, the first insulating member 340 is disposed between the negative terminal 320 and the housing 310 and is configured to electrically insulate at least a majority of the housing 310 from the negative terminal 320. In other words, disposing the first insulating member 340 between the negative terminal 320 and the housing 310 ensures that the housing 310 itself is not negatively charged, thereby lowering the risk of accidental short circuit.

In some embodiments, the first insulating member 340 can be interposed between the housing 310 and the negative terminal 320. In some embodiments, the first insulating member 340 can be interposed between the housing 310 and the positive terminal 330. In some embodiments, the first insulating member 340 and/or the second insulating member 350 can be interposed between the housing 310 and the negative terminal 320. In some embodiments, the second insulating member 350 can be interposed between the housing 310 and the positive terminal 330. In some embodiments, the first insulating member 340 can be interposed between the housing 310 and the negative terminal 320, and the second insulating member 350 can be interposed between the housing 310 and the positive terminal 330. In some embodiments, the first insulating member 340 can be interposed between the housing 310 and the positive terminal 330, and the second insulating member 350 can be interposed between the housing 310 and the negative terminal 320. In some embodiments, at least one of the first insulating member 340 and the second insulating member 350 can be interposed between separated pieces of the housing 310. In some embodiments, the first insulating member 340 and second insulating member 350 can be interchangeable and can provide a substantially similar insulating effect for the housing 310 in any position relative to the housing 310, the negative terminal 320, and the positive terminal 330.

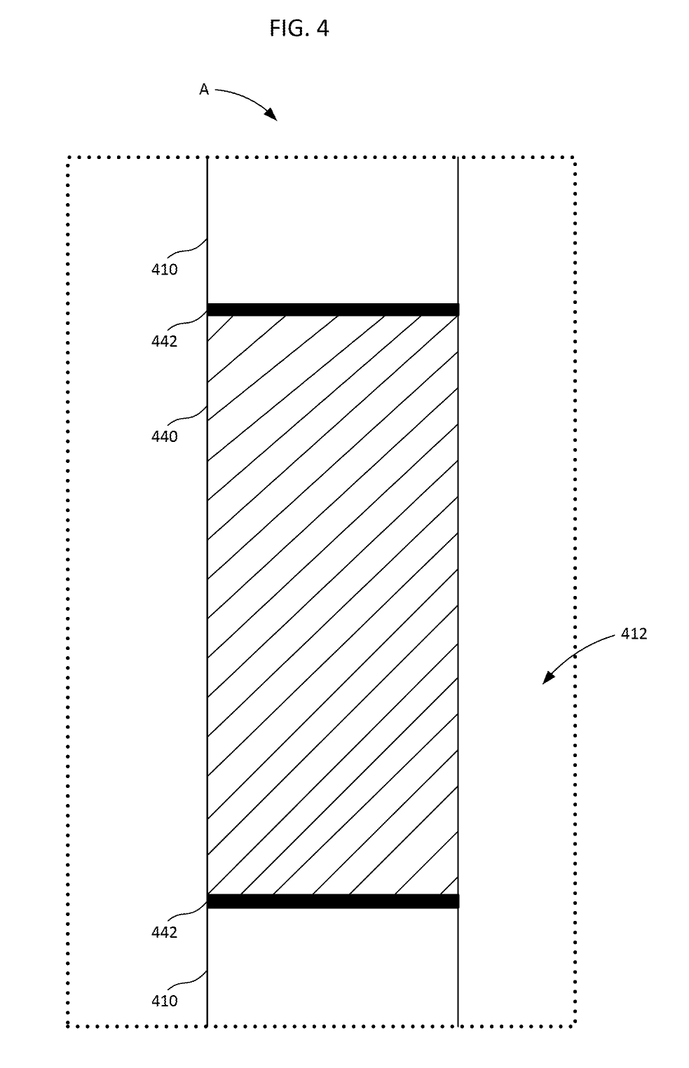

Referring now to FIGS. 4-6, an enlarged portion of the electrochemical cell 300 is shown identified by Arrow A in FIG. 3 (in the region of the first insulating member 340), according to several embodiments. FIG. 4 illustrates a portion of an electrochemical cell that includes a housing 410 defining an inner volume 412, and an insulating member 440. In some embodiments, the insulating member 440 is connected to the housing 410 via a fastening mechanism 442. Portions and/or aspects of the electrochemical cell shown in FIG. 4 or omitted in FIG. 4 can be substantially similar in form and/or function to the corresponding portions and/or aspects of the electrochemical cells 100, 200, and/or 300 described above. Accordingly, such similar portions and/or aspects are not described in further detail herein.

In some embodiments, the insulating member 440 can be glued to one or both of the housing 410 and a terminal. In some embodiments, the insulating member 440 can be thermochemically fused to at least one of the housing 410, the negative terminal 420, and the positive terminal 430. In some embodiments, the abutting surface of the housing 410 and/or a terminal 420 can be roughened and the insulating member 440 can be at least partially melted to join or affix one to the other. In some embodiments, the abutting surface of the insulating member 440 can be joined or affixed to the abutting surface of the housing 410 and/or the abutting surface of a terminal 420 can be brazed to make abutment permanent. In some embodiments, the abutting surface of the insulating member 440 can be joined or affixed to the abutting surface of the housing 410 and/or the abutting surface of a terminal 420 can be welded to make abutment permanent. In some embodiments, the abutting surface of the first insulating member 440 can be joined or affixed to the abutting surface of the housing 410 and/or the abutting surface of a terminal 420 can be soldered to make abutment permanent.

In some embodiments, the adhesive material can be structural adhesives, pressure sensitive adhesives, thermosetting structural adhesives, glue, cement, mucilage, paste, contact adhesives, hot adhesives, multi-component adhesives, ultraviolet light curing adhesives, light curing adhesives, thermoset epoxies, urethanes, polyimides, cyanoacrylates, polyols, acrylic polymers, ethylene-vinyl acetate hot melts, neoprene, caulk, casein-based glue, animal-based glue, methylcellulose-based adhesives, modified starch-based adhesives, polycarbophil, bisphenol A epoxy resin, bisphenol F epoxy resin, novolac epoxy resin, aliphatic epoxy resin, 3,4-epoxycyclohexlymethyl-3,4-epoxycyclohexane carboxylate, triglycidyl-p-aminophenol, N,N′,N″,N′″-tetraglycidyl-bis-(4-aminophenyl)-methan, amines, anhydrines, phenols, thiols, other compositions as suitable, or combinations thereof.

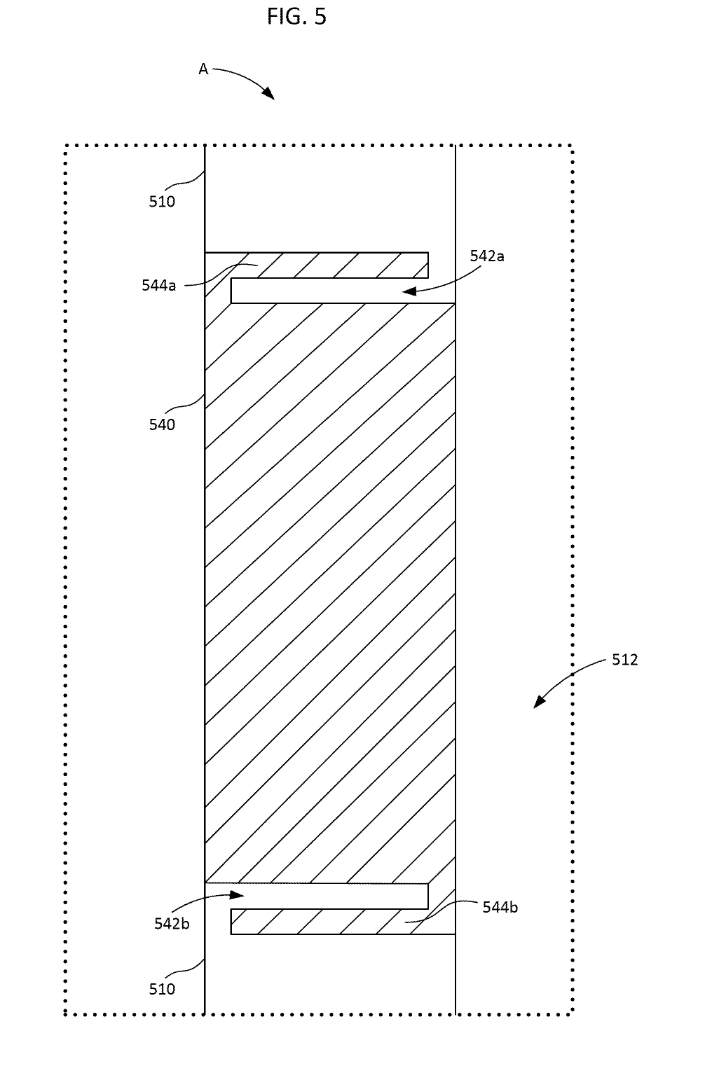

FIG. 5 illustrates a portion of an electrochemical cell that includes a housing 510 defining an inner volume 512, and an insulating member 540. Portions and/or aspects of the electrochemical cell shown in FIG. 5 or omitted in FIG. 5 can be substantially similar in form and/or function to the corresponding portions and/or aspects of the electrochemical cells 100, 200, and/or 300 described above. Accordingly, such similar portions and/or aspects are not described in further detail herein.

In some embodiments, one portion of the housing 510 includes a first lip 542a and another portion of the housing 510 or the negative terminal 520 includes a second lip 542b. The insulating member 540 includes a first groove 544a into which the first lip 542a of the housing 510 can be securely fitted, and a second groove 544b into which the second lip 542b of the housing 510 can be securely fitted. In some embodiments, at least one of the housing 510, the negative terminal 520, or the positive terminal 530, as well as the first insulating member 540, can have lips and or grooves that are dimensioned and configured in alternative ways to interconnect the housing 510 and the insulating member 540. In some embodiments, the lips 542a, 542b and/or grooves 544a, 544b can be abutted and calendared or crimped in order to make abutment permanent. In some embodiments, the first insulating member 540 can be fused to one or both of the housing 510 and a terminal. In some embodiments, the first insulating member 540 can be thermally bonded to one or both of the housing 510 and a terminal.

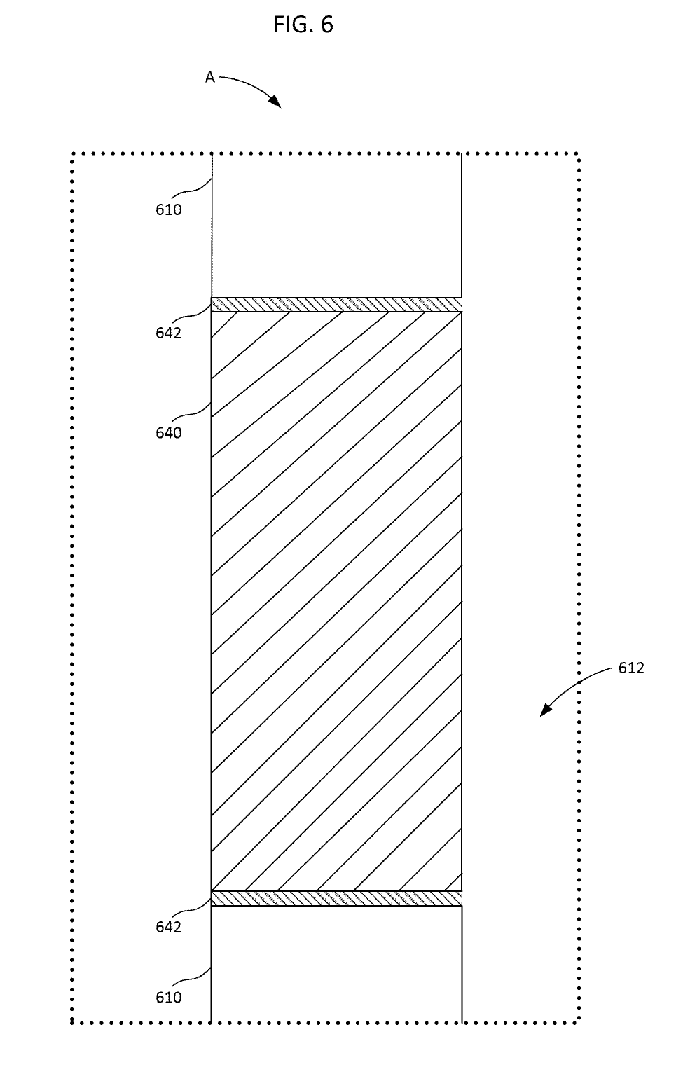

FIG. 6 illustrates a portion of an electrochemical cell that includes a housing 610 defining an inner volume 612, and an insulating member 640. Portions and/or aspects of the electrochemical cell shown in FIG. 6 or omitted in FIG. 6 can be substantially similar in form and/or function to the corresponding portions and/or aspects of the electrochemical cells 100, 200, and/or 300 described above. Accordingly, such similar portions and/or aspects are not described in further detail herein. In some embodiments, the electrochemical cell can include a fastening mechanism 642 such as a screw thread or a spiral ridge can be formed in the housing 610, the negative terminal 620, the positive terminal 630, and/or the insulating member 640. In some embodiments, the insulating member 640 can be screw fitted together with the housing 610 and/or a terminal such that the frictional engagement of threaded elements is sufficient to prevent linear motion being converted to rotary motion. In other words, the threaded elements do not become unthreaded due to motion, stress, temperature changes, and/or pressure changes within the electrochemical cell 600 or without. In addition, in some embodiments, the fastening mechanism 642 can later be “fused' to further secure the mechanical connection. In other words, in addition to the mechanical threading, the fastening mechanism 642 can be glued or otherwise thermally bonded to make the connection permanent.

To provide an overall understanding, certain illustrative embodiments have been described; however, it will be understood by one of ordinary skill in the art that the systems, apparatuses, and methods described herein can be adapted and modified to provide systems, apparatuses, and methods for other suitable applications and that other additions and modifications can be made without departing from the scope of the systems, apparatuses, and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems, apparatuses, or methods of the present disclosure.

It will be obvious to one of skill in the art that anode and cathode can be interchangeably applied to the electrode connected to the positive and/or negative terminals depending upon whether the electrochemical cell is charging or discharging. As such, any use of the term anode herein can alternatively relate to the cathode and any use of the term cathode herein can alternatively relate to the anode.

As used herein, the terms “about” and “approximately” generally mean plus or minus 10% of the value stated, for example about 250 μm would include 225 μm to 275 μm, approximately 1,000 μm would include 900 μm to 1,100 μm. As used herein, the term “substantially” generally means plus or minus 10% of the value stated. For instance, “substantially neutral charge” would mean a charge that is basically neutral but that can have a charge that is 10% or less of the negative or positive charge to which the neutral charge is compared.

The embodiments have been particularly shown and described, but it will be understood that various changes in form and details may be made.

Conventional terms in the fields of electrochemical cells have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Although specific embodiments have been illustrated and described herein, it will be appreciated by those of ordinary skill in the art that any arrangement that is adapted to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure and is submitted with the understanding that it will not be used to interpret or limit the scope or meaning of the claims.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

1. An electrochemical cell, comprising:
a housing including a first end portion and a second end portion and defining an inner volume therebetween;
an electrode assembly disposed in the inner volume, the electrode assembly including an anode, a cathode, and a separator disposed between the anode and the cathode;
a negative terminal disposed at the first end portion of the housing and electrically coupled to the anode of the electrode assembly;
a positive terminal disposed at the second end portion of the housing and electrically coupled to the cathode of the electrode assembly; and
an insulating member disposed between the negative terminal and the housing and configured to electrically insulate the housing from the negative terminal.

2. The electrochemical cell of claim 1, wherein the insulating member is a first insulating member, the electrochemical cell further comprising:
a second insulating member disposed between the positive terminal and the housing and configured to electrically insulate the housing from the positive terminal.

3. The electrochemical cell of claim 1, wherein the housing has a substantially neutral electrical potential.

4. The electrochemical cell of claim 1, wherein the housing is made from an insulating material.

5. The electrochemical cell of claim 4, wherein the housing and the insulating member are made from the same insulating material.

6. The electrochemical cell of claim 4, wherein the insulating material is selected from at least one of a glass, a polymer, a composite material, and combinations thereof.

7. The electrochemical cell of claim 1, wherein the housing is made from at least one of aluminum, zinc, steel, stainless steel, nickel, tin, copper, chromium, bronze, iron, lead, palladium, gold, cobalt, platinum, titanium, vanadium, molybdenum, rhodium, cadmium, tungsten, gallium, indium, iridium, bismuth, polonium, and any alloy or admixture thereof.

8. The electrochemical cell of claim 1, wherein the insulating member is made from at least one of a polymer, a plastic, ceramic, glass, fiberglass, acrylonitrile-butadiene-styrene, acetate, acrylic, polymerized formaldehyde, epoxy-fiberglass laminate, polystyrene, high impact polystyrene, polyimide, fluoropolymer, polyvinylidene fluoride, melamine laminated with woven glass, unfilled polyimide, mica, rubber, neoprene, aromatic polyamides, nylon, polyetheretherketone, polyethylene terephthalate, glycol-modified polyethylene terephthalate, phenolics, perfluoroalkoxy, polycarbonates, polyesters, polyolefins, polysulfones, polyurethanes, polytetrafluoroethylene, crosslinked polystyrene, polyphenylene sulfide, silicone-fiberglass resin, unfilled polyetherimide, vulcanized rubber, vulcanized fiber, dacron, mylar, polyvinylfluoride, polychlorinated biphenyls, and combinations thereof.

9. The electrochemical cell of claim 1, wherein the insulating member is a first insulating member, and the electrochemical cell further comprises:
a second insulating member disposed between the positive terminal and the housing and configured to electrically insulate the housing from the positive terminal, the second insulating member configured to be interchangeable with the first insulating member.

10. The electrochemical cell of claim 1, wherein the housing includes a first lip and a second lip and the insulating member includes a first groove and a second groove, the first groove configured to fit into the first lip and the second groove configured to fit into the second lip to interconnect the housing and the insulating member.

11. An electrochemical cell, comprising:
a housing including a first end portion and a second end portion and defining an inner volume therebetween;
an electrode assembly disposed in the inner volume, the electrode assembly including an anode, a cathode, and a separator disposed between the anode and the cathode;
a negative terminal disposed at the first end portion of the housing and electrically coupled to the anode of the electrode assembly;
a positive terminal disposed at the second end portion of the housing and electrically coupled to the cathode of the electrode assembly;
an first insulating member disposed between the negative terminal and the housing and configured to electrically insulate the housing from the negative terminal; and
a second insulating member disposed between the positive terminal and the housing and configured to electrically insulate the housing from the positive terminal,
wherein the housing has a substantially neutral electrical potential.

12. The electrochemical cell of claim 11, wherein the housing is made from an insulating material.

13. The electrochemical cell of claim 12, wherein the housing and the first insulating member are made from the same insulating material.

14. The electrochemical cell of claim 12, wherein the insulating material is selected from at least one of a glass, a polymer, a composite material, and combinations thereof.

15. The electrochemical cell of claim 11, wherein the housing is made from at least one of aluminum, zinc, steel, stainless steel, nickel, tin, copper, chromium, bronze, iron, lead, palladium, gold, cobalt, platinum, titanium, vanadium, molybdenum, rhodium, cadmium, tungsten, gallium, indium, iridium, bismuth, polonium, and any alloy or admixture thereof.

16. The electrochemical cell of claim 11, wherein the insulating member is made from at least one of a polymer, a plastic, ceramic, glass, fiberglass, acrylonitrile-butadiene-styrene, acetate, acrylic, polymerized formaldehyde, epoxy-fiberglass laminate, polystyrene, high impact polystyrene, polyimide, fluoropolymer, polyvinylidene fluoride, melamine laminated with woven glass, unfilled polyimide, mica, rubber, neoprene, aromatic polyamides, nylon, polyetheretherketone, polyethylene terephthalate, glycol-modified polyethylene terephthalate, phenolics, perfluoroalkoxy, polycarbonates, polyesters, polyolefins, polysulfones, polyurethanes, polytetrafluoroethylene, crosslinked polystyrene, polyphenylene sulfide, silicone-fiberglass resin, unfilled polyetherimide, vulcanized rubber, vulcanized fiber, dacron, mylar, polyvinylfluoride, polychlorinated biphenyls, and combinations thereof.

17. The electrochemical cell of claim 11, wherein the second insulating member is configured to be interchangeable with the first insulating member.

18. An electrochemical cell, comprising:
a housing including a first end portion and a second end portion and defining an inner volume therebetween, the first end portion including a first lip and the second end portion including a second lip;
an electrode assembly disposed in the inner volume, the electrode assembly including an anode, a cathode, and a separator disposed between the anode and the cathode;
a negative terminal disposed at the first end portion of the housing and electrically coupled to the anode of the electrode assembly;
a positive terminal disposed at the second end portion of the housing and electrically coupled to the cathode of the electrode assembly;
an first insulating member disposed between the negative terminal and the housing and configured to electrically insulate the housing from the negative terminal, the first insulating member including a first groove, the first groove configured to interconnect with the first lip of the housing; and
a second insulating member disposed between the positive terminal and the housing and configured to electrically insulate the housing from the positive terminal, the second insulating member including a second groove, the second groove configured to interconnect with the second lip of the housing,
wherein the housing has a substantially neutral electrical potential.

19. The electrochemical cell of claim 18, wherein the housing is made from an insulating material.

20. The electrochemical cell of claim 18, wherein the housing is made from an electrically conductive material.
